(19) United States
(12) Patent Application Publication
(10) Pub. No.: US 2013/0108732 A1
(43) Pub. Date: May 2, 2013

(54) Biodegradable Chewing Gum

(71) Applicants: Jesper Neergaard, Horning (DK); Helle Wittorff, Vejle Ost. (DK); Henriette Sie Woldum, Vejle (DK)

(72) Inventors: Jesper Neergaard, Horning (DK); Helle Wittorff, Vejle Ost. (DK); Henriette Sie Woldum, Vejle (DK)

(21) Appl. No.: 13/719,670

(22) Filed: Dec. 19, 2012

Related U.S. Application Data
(63) Continuation of application No. 13/040,980, filed on Mar. 4, 2011, now abandoned.
Application No. 13/040,980 is a continuation of application No. PCT/DK2008/000320, filed on Sep. 5, 2008.

(51) Int. Cl. A23G 4/08

(52) U.S. Cl. CPC A23G 4/08
USPC 426/3

(57) ABSTRACT

A chewing gum includes a polyester having as polyester-forming components in condensed form: (a) a dicarboxylic acid, (b) a diol and (c) a compound having at least three groups capable of ester formation in an amount of from 0.1 to 10.0% by weight, based on the total weight of components (a), (b) and (c). The polyester includes components (a) and (b) in an amount of at least 90% by weight, based on the total weight of the polyester. The chewing gum includes the polyester in an amount of at least 5% by weight of the chewing gum. The chewing gum further includes a sweetening agent and/or a flavoring agent in an amount of 10 to 95% by weight of the chewing gum. The molar ratio between aromatic acids and aliphatic acids of the dicarboxylic acid is between 0 and 1:4.2.

### FIELD OF THE INVENTION

The present invention relates to the field of chewing gum. In particular, the present invention provides a gum base and a chewing gum comprising a polyester polymer.

### BACKGROUND OF THE INVENTION

Over the recent years much attention has been brought to the field of chewing gum comprising biodegradable polymers.

The advantages in the application of biodegradable polymers in chewing gum are obvious, but it has been a problem to establish a chewing gum based on such polymers which inherit desirable texture and provide an attractive release of one of the most important chewing gum ingredients, namely sweetener.

A further problem related to chewing gums of the above-mentioned type is that these polymers may be relatively expensive, thereby rendering a chewing gum product relatively expensive when compared to conventional chewing gum.

Furthermore, chewing gum of the above mentioned type may be relatively difficult to remove when dropped on diverse surfaces such as carpets and pavements.

### SUMMARY OF THE INVENTION

The invention relates to a chewing gum comprising at least one polyester which comprises as polyester-forming components in condensed form
a) at least one dicarboxylic acid,
b) at least one diol and
c) at least one compound having at least three groups capable of ester formation in an amount of from 0.1 to 10.0% by weight, based on the total weight of components a), b) and c)

wherein the polyester comprises the components a) and b) in an amount of at least 90% by weight, based on the total weight of the polyester,

wherein the chewing gum comprises said polyester in an amount of at least 5% by weight of said chewing gum,

wherein the chewing gum comprises further chewing gum ingredients selected from the group consisting of at least one sweetening agent and at least one flavoring agent in an amount of 10 to 95% by weight of the chewing gum and wherein

the molar ratio between aromatic acids and aliphatic acids of said dicarboxylic acid in the chewing gum is between 0 and 1:4.2.

The chewing gum of the present invention features excellent sweetener release characteristics and at the same time, a favorable texture of the chewing gum is provided. Surprisingly, it has been found that the content of aromatic acid in the polyester backbone may be used to tune the texture of the chewing gum. On the other hand, the molar content of aromatics should be kept comparatively low in order to facilitate optimal degradability of the polyester. In cases where a comparatively soft chewing gum is desired, a low molar ratio between aromatic acids and aliphatic acids is chosen, and in some cases, the use of aromatic acids may be completely avoided.

In cases where a firmer chewing gum texture is desired, a higher molar ratio between aromatic acids and aliphatic acids is preferred.

However, to ensure good degradability of the chewing gum of the present invention, the molar ratio between aromatic- and aliphatic carboxylic acids should be kept within 0 and 1:4.2.

Because of the good release of sweeteners and flavors from the chewing gum of the present invention a wide range of flavor- and sweetener contents may advantageously be used, although a minimum of about 10% by weight of the chewing gum of sweeteners and flavors may be necessary to achieve an acceptable taste profile.

Use of appropriate amounts of compound c) ensures that the build up of crystalline domains in the polymer may be suppressed through a moderate degree of branching, thereby providing the chewing gum of the present invention with a desired texture.

According to an advantageous embodiment of the invention, 10% by weight of compound c) is present among the polyester forming ingredients based on the total weight of the polyester forming ingredients.

According to an advantageous embodiment of the invention, 5% by weight of compound c) is present among the polyester forming ingredients based on the total weight of the polyester forming ingredients.

According to an advantageous embodiment of the invention, 3% by weight of compound c) is present among the polyester forming ingredients based on the total weight of the polyester forming ingredients.

According to an advantageous embodiment of the invention, a polyester of the claimed type may be applied in a chewing gum together with chewing gum ingredients comprising sweetening agents and flavouring agents and result in a chewing gum having advantageously textural properties.

Moreover, the chewing gum according the invention features advantageous release of sweeteners and flavours in combination with advantageous degradability properties of the applied polyester.

The degradability of the applied polymer may also facilitate advantageous non-tack properties even when combined with conventional polymers.

When applying biodegradable elastomeric and/or resins in chewing gum and avoiding conventional non-bio-degradable elastomers such as SBR and PIB and resins such ad natural resins and PVA, a completely biodegradable chewing gum may be obtained.

In the present context the weight reference is typically referred to the chewing gum excluding optional coating.

In an embodiment of the invention said sweetening agent is selected from the group comprising bulk sweeteners, high intensity sweeteners and/or combinations thereof.

In an embodiment of the invention said sweetening agent comprises sugar.

In an embodiment of the invention said chewing gum is sugar free.

In an embodiment of the invention said bulk sweeteners comprises an amount of about 5 to about 95%, preferably about 20 to about 80% by weight of the chewing gum.

Suitable bulk sweeteners include both sugar and non-sugar sweetening components. Bulk sweeteners typically constitute from about 5 to about 95% by weight of the chewing gum, more typically about 20 to about 80% by weight such as 30 to 60% by weight of the gum.

In an embodiment of the invention the chewing gum comprises high intensity sweeteners in an amount of about 0 to about 1.2%, preferably about 0.1 to about 0.6% by weight of the chewing gum.

In an embodiment of the invention said flavoring agents comprise natural and synthetic flavorings in the form of natural vegetable components, essential oils, essences, extracts, powders, including acids and other substances capable of affecting the taste profile.

In an embodiment of the invention said chewing gum comprises flavor in an amount of 0.01 to about 25 wt %, preferably in an amount of 0.1 to about 5 wt %, said percentage being based on the total weight of the chewing gum.

In an embodiment of the invention the dicarboxylic acid is selected from α,ω-alkane dicarboxylic acid having from 4 to 12 carbon atoms.

In an embodiment of the invention the dicarboxylic acid is selected from succinic acid, adipic acid and sebacic acid.

In an embodiment of the invention one of said dicarboxylic acid is selected from aromatic acids in which two carboxyl groups are bound to one aromatic entity, for example naphtyl, phenyl or pyridyl and wherein the molar ratio between the aromatic dicarboxylic acid and the aliphatic dicarboxylic acid of said dicarboxylic acids is between 0 and 1:4.2.

In an embodiment of the invention the said at least one polyester is substantially free of aromatic dicarboxylic acid component, meaning that the molar ratio between the aromatic dicarboxylic acid and the aliphatic dicarboxylic acid of said dicarboxylic acids is 0.

In an embodiment of the invention, the aromatic dicarboxylic acid is selected from phthalic acid, terephthalic acid, isophthalic acid and mixtures thereof.

In an embodiment of the invention the diol is selected from diols having at least one branching point, a saturated cyclic structure and/or at least one ether group.

In an embodiment of the invention the diol is selected from propane-1,2-diol, propane-1,3-diol, 2,2-dimethylpropane-1,3-diol, diethylene glycol, triethylene glycol, tetraethylene glykol or 1,4-cyclohexanedimethanol.

In an embodiment of the invention the diol is selected from aromatic diols in which two hydroxyl groups are bound to one aromatic entity, for example naphtyl, phenyl og pyridyl and wherein the molar ratio between the aromatic diol and the aliphatic diol of said diols is between 0 and 1:4.2.

In an embodiment of the invention the said at least one polyester is substantially free of aromatic diol component, meaning that the molar ratio between the aromatic diol acid and the aliphatic diol acid of said diols is 0.

In an embodiment of the invention, the aromatic diol is selected from dihydroxy phenols, for example resorcinol.

In an embodiment of the invention the polyester contains the components a) and b) in a molar ratio a):b) of from 0.95:1 to 1.05:1.

In an embodiment of the invention the compound having at least three groups capable of ester formation is selected from tartaric acid, citric acid, malic acid, trimethylolpropane, trimethylolethane, pentaerythritol, polyethertriols, glycerol, trimesic acid, trimellitic acid, pyromellitic acid and hydroxyisophthalic acid.

In an embodiment of the invention the compound having at least three groups capable of ester formation is selected from glycerol and pentaerythritol.

In an embodiment of the invention the polyester contains the component c) in an amount of from 1.0 to 5.0% by weight, based on the total weight of the polyester.

In an embodiment of the invention the polyester has a viscosity number in the range of from 50 to 500 mL/g.

In an embodiment of the invention the polyester has a polydispersity index (Mw/Mn) of at least 2.

In an embodiment of the invention the polyester comprises not more than 20% by weight of an aromatic dicarboxylic acid based on the total weight of the polyester-forming components.

In an embodiment of the invention said at least one polyester has a molecular weight (Mw) in the range of 20,000 to 1,000,000 g/mol.

In an embodiment of the invention said biodegradable polymer has a molecular weight (Mw) in the range of 20,000 to 1,000,000 g/mol.

When applying a relative high molecular weight of the polyester used in the chewing gum according to an embodiment of the invention, the chewing gum obtains advantageous robust properties with respect to chewing gum ingredients added to the chewing gum.

In a further advantageous embodiment of the invention said biodegradable polymer has a molecular weight (Mw) in the range of 40,000 to 1,000,000 g/mol.

In an embodiment of the invention said at least one polyester has a molecular weight (Mw) of at least 40,000 g/mol.

In an embodiment of the invention said at least one polyester has a molecular weight (Mw) of at least 50,000 g/mol.

In an embodiment of the invention said at least one polyester has a molecular weight (Mw) of at least 60,000 g/mol.

In an embodiment of the invention said at least one polyester has a molecular weight (Mw) of at least 70,000 g/mol.

In an embodiment of the invention said at least one polyester is elastomeric and wherein said chewing gum comprises said elastomeric polyester in an amount of at least 0.5%, preferably at least 1% by weight of the chewing gum.

In an embodiment of the invention said at least one polyester is elastomeric and wherein said chewing gum comprises said elastomeric polyester in an amount of at least 2%, preferably at least 3% by weight of the chewing gum.

In an embodiment of the invention said at least one polyester is elastomeric and wherein said chewing gum comprises said elastomeric polyester in an amount within the range of about 0.5% to 40% by weight of the chewing gum.

In an embodiment of the invention said chewing gum comprises at least one further elastomeric polymer.

Preferably, the further elastomeric polymer has a molecular weight deviating from the polymer applied according to the provisions of the invention.

The further elastomeric polymer may be a conventional elastomeric polymer such as PIB and/and SBR. Preferably, the further elastomeric polymer is chosen amongst biodegradable polymers.

In an embodiment of the invention said chewing gum comprises three or more elastomeric polymers.

In an embodiment of the invention the chewing further comprises at least one elastomer plasticizer.

In an embodiment of the invention said at least one elastomer plasticizer comprises a resin.

In an embodiment of the invention said resin is biodegradable.

According to a further advantageous embodiment, the biodegradable polymer forming a resin should preferably be synthetic.

In an embodiment of the invention said resin is a polyester.

In an embodiment of the invention said biodegradable resin is a polyester polymer obtainable by ring-opening polymerization of cyclic monomers.

In an embodiment of the invention said cyclic monomers are selected from the group of cyclic esters and cyclic carbonates.

In an embodiment of the invention said cyclic monomers are selected from the group of D,L-lactide, L-lactide, glycolide, 8-caprolactone, 6-valerolactone, trimethylene carbonate (TMC) and dioxanone.

In an embodiment of the invention said chewing gum further comprises an additional biodegradable chewing gum resinous or elastomeric polymers selected from the group of polyesters, polycarbonates, polyester amides, polypeptides, homopolymers of amino acids such as polylysine, and proteins including derivatives hereof such as e.g. protein hydrolysates including a zein hydrolysate.

In an embodiment of the invention said chewing gum is substantially free non-degradable polymers.

According to a preferred embodiment of the invention all elastomers and resins are biodegradable.

In an embodiment of the invention the chewing gum comprises in the amount of 1 to 30% by weight of elastomeric polymers and 3 to 70% by weight of resinous polymers.

By obtaining a certain balance between the amount of resinous polymers and elastomeric polymers in the final chewing gum attractive texture may be obtained together with acceptable release of chewing gum ingredients, typically sweetening and flavoring agents. Active ingredients may moreover be released in a satisfactory way.

It is noted that the elastomeric polymers may be comprised by one or several elastomeric polymers and that the resinous polymers may comprise one or several resinous polymers.

In an embodiment of the invention the chewing gum comprises filler in an amount of 0.25%-50% by weight of the chewing gum.

According to an advantageous embodiment of the invention chewing gum may comprise filler to reduce the manufacturing costs but at the same time maintain acceptable release and textural properties when applying a polymer according to the provisions of the invention.

According to a preferred embodiment of the invention filler should comprise less that 35% by weight of the gum base components.

In an embodiment of the invention the chewing gum comprises filler in an amount of 0.25%-35% by weight of the chewing gum.

In an embodiment of the invention the chewing gum comprises filler in an amount of 0.25%-25% by weight of the chewing gum.

In an embodiment of the invention chewing gum comprise one or more fillers selected from the group of magnesium and calcium carbonate, sodium sulphate, ground limestone, silicate compounds such as magnesium and aluminum silicate, kaolin and clay, aluminum oxide, silicon oxide, talc, titanium oxide, mono-, di- and tri-calcium phosphates, cellulose polymers, such as wood, and or combinations thereof.

In an embodiment of the invention the chewing gum comprises at least one softener in an amount of about 0 to about 20% by weight of the chewing gum, more typically about 0 to about 10% by weight of the chewing gum.

In an embodiment of the invention the chewing gum comprises emulsifier is in the range of 0 to 18% by weight of the chewing gum.

In an embodiment of the invention the chewing gum comprises at least one coloring agent.

In an embodiment of the invention said chewing gum ingredients comprise active ingredients.

In an embodiment of the invention said chewing gum is coated with an outer coating selected from the group comprising hard coating, soft coating and edible film-coating.

In an embodiment of the invention said chewing gum is compressed.

The chewing gum is preferably provided by compression of gum base-containing chewing gum granules with or without chewing gum ingredients. The gum base-containing chewing gum granules may also be mixed with granules without gum base components if so desired.

In an embodiment of the invention, the dicarboxylic acid is aliphatic.

In an embodiment of the invention the diol is aliphatic.

In an embodiment of the invention the molar ration between aromatic acids and aliphatic acids of said dicarboxylic acid in the chewing gum is between 1:100 and 1:5.

In an embodiment of the invention the molar ratio between aromatic acids and aliphatic acids of said dicarboxylic acid in the chewing gum is between 0 and 1:5.

### DETAILED DESCRIPTION OF THE INVENTION

Biodegradability according to the invention, is defined as a property of certain organic molecules that, when exposed to the natural environment or placed within a living organism, react through enzymatic or microbial processes, often in combination with a chemical process such as hydrolysis or photochemical bond cleavage by the UV-portion of sunlight, to form simpler compounds, and ultimately carbon dioxide, nitrogen oxides, methane, water and the like.

In the present context the term ‘biodegradable polymers’ means environmentally or biologically degradable polymer compounds and refers to chewing gum base components which, after dumping the chewing gum, are capable of undergoing a physical, chemical and/or biological degradation, whereby the dumped chewing gum waste becomes more readily removable from the site of dumping or is eventually disintegrated to lumps or particles, which are no longer recognizable as being chewing gum remnants. The degradation or disintegration of such degradable polymers may be effected or induced by physical factors such as temperature, light, moisture, etc., by chemical factors such as oxidative conditions, pH, hydrolysis, etc. or by biological factors such as microorganisms and/or enzymes. The degradation products may be larger oligomers, trimers, dimers and monomers.

Preferably, the ultimate degradation products are small compounds such as carbon dioxide, nitrogen oxides, methane, ammonia, water, etc.

As referred to herein, the glass transition temperature (Tg) is be determined by for example DSC (DSC: differential scanning calorimetry). The DSC may generally be applied for determining and studying of the thermal transitions of a polymer and specifically, the technique may be applied for the determination of a second order transition of a material. The transition at Tg is regarded as such a second order transition, i.e. a thermal transition that involves a change in heat capacity, but does not have a latent heat. Hence, DSC may be applied for studying Tg. Unless otherwise stated the heating rate used is 10° C./min throughout the application.

Unless otherwise indicated, as used herein with regard to polymers, the term “molecular weight” means weight average molecular weight (Mw) in g/mol. Furthermore, as used herein the short form PD designates the polydispersity of polymers, polydispersity being defined as Mw/Mn, where Mw is the weight average molecular weight of a polymer. A well-established technique for characterization of biodegradable polymers is gel permeation chromatography (GPC).

The viscosity number (VN) used herein and expressed in milliliter/gram is defined as the specific viscosity of the polymer divided by the concentration of the polymer in a solvent expressed in grams of polymer pr. milliliter of solvent.

Measurements where done in o-dichlorobenzene/phenol (weight ratio 1:1) at a concentration of 0.5% by weight of polyester at 25° C. in accordance with EN ISO 1628-1.

In the present text, it is assumed that the temperature in the mouth of the chewing gum consumer is about human body temperature, although it may practically during chewing be a few degrees below body temperature. A glass transition temperature above mouth temperature is herein referred to as a high Tg, whereas a Tg below mouth temperature is herein referred to as a low Tg.

Chewing gum of the present invention typically comprises a water-soluble bulk portion, a water-insoluble chewable gum base portion and flavoring agents. The water-soluble portion dissipates with a portion of the flavoring agent over a period of time during chewing. The gum base portion is retained in the mouth throughout the chew. The term chewing gum refers to both a chewing and bubble type gum in its general sense.

The gum base is the masticatory substance of the chewing gum, which imparts the chew characteristics to the final product. The gum base typically defines the release profile of flavors and sweeteners and plays a significant role in the gum product.

The insoluble portion of the gum typically may contain any combination of elastomers, vinyl polymers, elastomer plasticizers, waxes, softeners, fillers and other optional ingredients such as colorants and antioxidants.

The composition of gum base formulations can vary substantially depending on the particular product to be prepared and on the desired masticatory and other sensory characteristics of the final product. However, typical ranges (% by weight) of the above gum base components are: 5 to 80% by weight elastomeric compounds, 5 to 80% by weight elastomer plasticizers, 0 to 40% by weight of waxes, 5 to 35% by weight softener, 0 to 50% by weight filler, and 0 to 5% by weight of miscellaneous ingredients such as antioxidants, colorants, etc. The gum base may comprise about 5 to about 95 percent, by weight, of the chewing gum, more commonly, the gum base comprises 10 to about 60 percent of the gum.

Elastomers provide the rubbery, cohesive nature to the gum, which varies depending on this ingredient's chemical structure and how it may be compounded with other ingredients. Elastomers suitable for use in the gum base and gum of the present invention may include natural or synthetic types.

Elastomer plasticizers vary the firmness of the gum base. Their specificity on increasing long-range segmental motion of the polymer molecules (plasticizing) along with their varying softening points cause varying degrees of finished gum firmness and compatibility when used in base. This may be important when one wants to provide more elastomeric chain exposure to the alkane chains of the waxes.

An elastomer plasticizer may also sometimes be referred to as a resin or as a resinous polymer.

At least one elastomer compound(s) may preferably be biodegradable. Further elastomers may be biodedegradable or conventional. The conventional may be of natural origin or synthetic. According to the invention, the resin compounds are preferably one or more biodegradable polymers and these polymers may preferably be synthetic. Natural resins of any kind are avoided in the chewing gum according to a preferred embodiment of the present invention.

According to a preferred embodiment of the invention all elastomers and resins are biodegradable.

An important polymer to be applied in a chewing gum according to the present invention is a chewing gum comprising at least one polyester which comprises as polyester-forming components in condensed form
a) at least one dicarboxylic acid,
b) at least one diol and
c) at least one compound having at least three groups capable of ester formation in an amount of from 0.1 to 10.0% by weight, based on the total weight of components a), b) and c),

wherein the polyester comprises the components a) and b) in an amount of at least 90% by weight, based on the total weight of the polyester.

According to different embodiments of the invention, 6, 4, 2, 1.5 or 1% by weight of compound c) is present among the polyester forming ingredients based on the total weight of the polyester forming ingredients.

Chewing gum of the present invention typically contains comparatively small amounts of aromatics in the fraction of the said at least one polyester in the gum base. This leads to better biodegradability, as evidenced by example 16.

In an embodiment of the invention, the fraction of said at least one polyester in the gum base is essentially free of aromatic components (acids, alcohols, polyfunctionals).

According to the present invention, the chewing gum preferably comprises at least one biodegradable resinous polymer having a Tg being above −20° C. Here below a series of examples of monomer compositions are given, which in tuned molar ratios may be applied for a resinous biodegradable polymer, which may be applied as part of a chewing gum according to an embodiment of the present invention.

According to different embodiments of the invention, a biodegradable polymer may comprise at least one of the high-Tg-inducing monomers chosen among lactides or glycolides and possibly one or more low-Tg-inducing monomers chosen among lactones and cyclic carbonates.

The lactone monomers may be selected from the group of ε-caprolactone, δ-valerolactone, γ-butyrolactone, and β-propiolactone, also including ε-caprolactones, δ-valerolactones, γ-butyrolactones, or β-propiolactones that have been substituted with one or more alkyl or aryl substituents at any non-carbonyl carbon atoms along the ring. The carbonate monomers may be chosen from the group of trimethylene carbonate, 5-alkyl-1,3-dioxan-2-one, 5,5-dialkyl-1,3-dioxan-2-one, or 5-alkyl-5-alkyloxycarbonyl-1,3-dioxan-2-one, ethylene carbonate, 3-ethyl-3-hydroxymethyl, propylene carbonate, trimethylolpropane monocarbonate, 4,6-dimethyl-1,3-propylene carbonate, 2,2-dimethyl trimethylene carbonate, and 1,3-dioxepan-2-one.

According to the present invention, some suitable monomers are cyclic monomers such as D,L-lactide, L-lactide, and glycolide, which are high-Tg-inducing, and 8-caprolactone, δ-valerolactone, trimethylene carbonate (TMC) and dioxanone, which are low-Tg-inducing.

When desiring a high Tg resin, i.e. a resin having a Tg above mouth temperature, either homo-polymers or co-polymers of high-Tg-inducing monomers alone are used, or a combination of high- and low-Tg inducing monomers are used, wherein it is important that the ratio between high-Tg inducing monomers and low-Tg inducing monomers is controlled.

According to an embodiment of the invention, some examples of homo-polymers or co-polymers of high-Tg-inducing monomers may include the following: poly(L-lactide); poly(D-lactide); poly(D,L-lactide); poly(mesolactide); poly(glycolide); poly(L-lactide-co-D, L-lactide); poly(L-lactide-co-meso-lactide); poly(L-lactide-co-glycolide); poly(D,L-lactide-co-meso-lactide); poly(D,L-lactide-co-glycolide); poly(mesolactide-co-glycolide), etc.

According to a further embodiment of the invention, one or more high-Tg-inducing monomers and one or more low-Tg-inducing monomers may be polymerized together, the molar ratio of high/low being in the range of 75/25 to 99/1, preferably in the range of 85/15 to 99/1, and typically in the range of 95/5 to 99/1. In other words, the mol percentage of high-Tg-inducing monomers is at least 75%, preferably at least 85%, and typically at least 95% of the total mol number of monomers forming the resulting polymer when a high Tg resin is desired. Conversely, when a low Tg resin is desired, these ratios may differ significantly. In order to obtain a resinous polymer based on these monomers and having a Tg at about or lower than mouth temperature the molar ratio of high/low may e.g. be in the range of 40/60 to 1/99. While considering these ratios, preferred combinations of cyclic monomers may include the following:
D,L-lactide/ε-caprolactone,
D,L-lactide/TMC
D,L-lactide/δ-valerolactone
D, L-lactide/dioxanone
D,L-lactide in combination with any two, three, or four low Tg-inducing monomers
L-lactide/ε-caprolactone
L-lactide/TMC
L-lactide/δ-valerolactone
L-lactide/dioxanone
L-lactide in combination with any two, three, or four low Tg-inducing monomers
D,L-lactide/glycolide/ε-caprolactone
D, L-lactide/glycolide/TMC
D,L-lactide/glycolide/δ-valerolactone
D, L-lactide/glycolide/dioxanone
D,L-lactide/glycolide in combination with any two, three, or four low Tg-inducing monomers
L-lactide/glycolide/ε-caprolactone
L-lactide/glycolide/TMC
L-lactide/glycolide/δ-valerolactone
L-lactide/glycolide/dioxanone
L-lactide/glycolide in combination with any two, three, or four low Tg-inducing monomers
glycolide/ε-caprolactone
glycolide/TMC
glycolide/δ-valerolactone
glycolide/dioxanone
glycolide in combination with any two, three, or four low Tg-inducing monomers
D,L-lactide/L-lactide/ε-caprolactone
D, L-lactide/L-lactide/TMC
D,L-lactide/L-lactide/δ-valerolactone
D,L-lactide/L-lactide/dioxanone
D,L-lactide/L-lactide in combination with any two, three, or four low Tg-inducing monomers
D,L-lactide/L-lactide/glycolide/ε-caprolactone
D, L-lactide/L-lactide/glycolide/TMC
D,L-lactide/L-lactide/glycolide/δ-valerolactone
D,L-lactide/L-lactide/glycolide/dioxanone
D,L-lactide/L-lactide/glycolide in combination with any two, three, or four low Tg-inducing monomers

The polymerization of monomers according to the above compositions may according to the invention lead to some highly degradable polymers, which are suitable as resinous compounds in the chewing gum of the present invention.

A few examples of such resulting biodegradable polymers applicable as resins may include but or not limited to poly(L-lactide-co-trimethylenecarbonate); poly(L-lactide-co-epsilon-caprolactone); poly (D,L-lactide-co-trimethylenecarbonate); poly (D,L-lactide-co-epsilon-caprolactone); poly(meso-lactide-co-trimethylenecarbonate); poly(mesolactide-co-epsilon-caprolactone); poly(glycolide-cotrimethylenecarbonate); poly(glycolide-co-epsilon-caprolactone), etc.

According to an embodiment of the invention, the polymerization process to obtain the biodegradable polymer, which is applied in the chewing gum of the present invention, may be initiated by an initiator such as a polyfunctional alcohol, amine or other molecules or compounds with multiple hydroxyl or other reactive groups or mixtures thereof.

According to an embodiment of the invention, examples of suitable multifunctional initiators include but are not limited to glycerol, trimethylolpropane, pentaerythritol, dipentaerythritol, and ethoxylated or propoxylated polyamines.

Furthermore, in a preferred embodiment of the invention, the initiator may be di-functional, and examples of applicable di-functional initiators include di-functional alcohols, and non-limiting examples include 1,2-propane diol, 1,3-propane diol, 1,3-butane diol, other alkane diols, ethylene glycol, generally alcohols having two hydroxyl groups, and other di-functional compounds capable of initiating a ring-opening polymerization.

Furthermore, according to the invention, the biodegradable polyester may comprise initiator in the range of 0.01 to 1.0, preferably 0.05 to 0.8 weight % of the biodegradable polyester.

According to an embodiment of the invention, the fraction of initiators in the biodegradable polymer being difunctional or higher functional may be regulated, whereby the degree of linearity and branching may be controlled.

In an embodiment of the invention, the difunctional initiators comprise at least 50 mol % of the total content of initiator molecules applied. Hereby, a considerable linearity may be introduced in the biodegradable polymer according to the present invention, and a certain desired crystallinity may be obtained. Hereby, the biodegradable polyester polymer may gain very suitable properties as elastomer plasticizer, and hence an advantageous biodegradable resin may be provided in the chewing gum of the present invention. To increase the linearity to improve the crystallinity, plasticizing properties and robustness of the chewing gum in an embodiment of the invention, the content of difunctional initiators may be raised to e.g. 60%, 70%, 80%, 90%, or about 100% of the total content of moles initiator molecules applied.

Accordingly, a substantially linear polyester polymer may according to an embodiment of the invention comprise above e.g. 50 or 80 percent linear polymer chains.

A biodegradable resinous polymers applicable in an embodiment of the present invention may e.g. be obtainable by ring-opening polymerization. However, the method of production is not limiting for the scope of the present invention. As an example, ring-opening polymerization of lactide is more commonly used as production method than polycondensation of lactic acid (e.g. α-hydroxypropionic acid). This, however, is mainly a matter of process conditions and ease of production. As concerns the resulting polymers, they may be provided with substantially the same composition and properties and being equally applicable in chewing gum according to the present invention. The naming of such polymers is often regarded inter-changeable, thus the names poly(lactide) and poly(lactic acid) may be used for the same polymer.

Generally, the biodegradable polymers used in the chewing gum of the present invention may be homopolymers, copolymers or terpolymers, including graft- and block-polymers.

Alternative biodegradable polymers other than the above indicated resinous polymers may be applied within the scope of the invention as resins. Such polymers may also include a large variety of polyesters obtained through poly-condensation.

Useful polymers, which may be applied as resins in the chewing gum of the present invention, may also be prepared by step-growth polymerization of di-, tri- or higher-functional alcohols or esters thereof with di-, tri- or higher-functional aliphatic or aromatic carboxylic acids or esters thereof. Likewise, also hydroxy acids or anhydrides and halides of polyfunctional carboxylic acids may be used as monomers. The polymerization may involve direct polyesterification or transesterification and may be catalyzed.

Useful polymers, which may be applied as elastomers in the chewing gum of the present invention, may generally be prepared by step-growth polymerization of di-, tri- or higher-functional alcohols or esters thereof with di-, tri- or higher-functional aliphatic or aromatic carboxylic acids or esters thereof. Likewise, also hydroxy acids or anhydrides and halides of polyfunctional carboxylic acids may be used as monomers. The polymerization may involve direct polyesterification or transesterification and may be catalyzed.

Because polyfunctional carboxylic acids in general are high-melting solids that have very limited solubility in the polycondensation reaction medium, esters or anhydrides of the polyfunctional carboxylic acids are often used to overcome this limitation. Furthermore, polycondensations involving carboxylic acids or anhydrides produce water as the condensate, which requires high temperatures to be driven off. Thus, polycondensations involving transesterification of the ester of a polyfunctional acid are often the preferred process. For example, the dimethyl ester of terephthalic acid may be used instead of terephthalic acid itself. In this case, methanol rather than water is condensed, and the former can be driven off more easily than water. Usually, the reaction is carried out in the bulk (no solvent) and high temperatures and vacuum are used to remove the by-product and drive the reaction to completion.

Specific examples of aliphatic polyfunctional carboxylic acids, which may be useful in the preparation of an elastomer applied in the chewing gum of the present invention, include oxalic, malonic, citric, succinic, malic, tartaric, fumaric, maleic, glutaric, glutamic, adipic, glucaric, pimelic, suberic, azelaic, sebacic, dodecanedioic acid, etc. Likewise, specific examples of aromatic polyfunctional carboxylic acids may be terephthalic, isophthalic, phthalic, trimellitic, pyromellitic and naphthalene 1,4-, 2,3-, 2,6-dicarboxylic acids and the like.

For the purpose of illustration and not limitation, some examples of carboxylic acid derivatives, which may be used for preparation of the elastomer used in the chewing gum of the present invention, include hydroxy acids such as 3-hydroxy propionic acid and 6-hydroxycaproic acid and anhydrides, halides or esters of acids, for example dimethyl or diethyl esters, corresponding to the already mentioned acids, which means esters such as dimethyl or diethyl oxalate, malonate, succinate, fumarate, maleate, glutarate, adipate, pimelate, suberate, azelate, sebacate, dodecanedioate, terephthalate, isophthalate, phthalate, etc. Generally speaking, methyl esters are sometimes more preferred than ethyl esters due to the fact that higher boiling alcohols are more difficult to remove than lower boiling alcohols.

The usually preferred polyfunctional alcohols contain 2 to 100 carbon atoms as for instance polyglycols and polyglycerols.

In the polymerization of an elastomer for use in the chewing gum of the present invention, some applicable examples of alcohols, which may be employed as such or as derivatives thereof, include polyols such as ethylene glycol, 1,2-propanediol, 1,3-propanediol, 1,3-butanediol, 1,4-butanediol, 1,6-hexanediol, diethylene glycol, triethylene glycol, tetraethylene glycol, 1,4-cyclohexanediol, 1,4-cyclohexanedimethanol, neopentyl glycol, glycerol, trimethylolpropane, pentaerythritol, sorbitol, mannitol, etc.

Generally, the elastomer polymers used in the chewing gum of the present invention may be homopolymers, copolymers or terpolymers, including graft- and block-polymers.

Further suitable examples of additional environmentally or biologically degradable chewing gum base polymers, resinous or elastomeric, which may be applied in accordance with the gum base of the present invention, include degradable polyesters as already mentioned above, polycarbonates, polyester amides, polypeptides, homopolymers of amino acids such as polylysine, and proteins including derivatives hereof such as e.g. protein hydrolysates including a zein hydrolysate.

In accordance with the general principles in manufacturing a chewing gum within the scope of the invention, variations of different suitable ingredients are listed and explained below.

The chewing gum according to the invention may comprise coloring agents. According to an embodiment of the invention, the chewing gum may comprise color agents and whiteners such as FD&C-type dyes and lakes, fruit and vegetable extracts, titanium dioxide and combinations thereof.

Further useful chewing gum base components include antioxidants, e.g. butylated hydroxytoluene (BHT), butyl hydroxyanisol (BHA), propylgallate and tocopherols, and preservatives.

In an embodiment of the invention, the chewing gum comprises softeners in an amount of about 0 to about 18% by weight of the chewing gum, more typically about 0 to about 12% by weight of the chewing gum.

Softeners/emulsifiers may according to the invention be added both in the chewing gum and the gum base.

A gum base formulation may, in accordance with the present invention, comprise one or more softening agents e.g. sucrose esters including those disclosed in WO 00/25598, which is incorporated herein by reference, tallow, hydrogenated tallow, hydrogenated and partially hydrogenated vegetable oils, cocoa butter, degreased cocoa powder, glycerol monostearate, glyceryl triacetate, lecithin, mono-, di- and triglycerides, acetylated monoglycerides, fatty acids (e.g. stearic, palmitic, oleic and linoleic acids) and combinations thereof. As used herein the term “softener” designates an ingredient, which softens the gum base or chewing gum formulation and encompasses waxes, fats, oils, emulsifiers, surfactants and solubilisers.

To soften the gum base further and to provide it with water-binding properties, which confer to the gum base a pleasant smooth surface and reduce its adhesive properties, one or more emulsifiers is/are usually added to the composition, typically in an amount of 0 to 18% by weight, preferably 0 to 12% by weight of the gum base. Mono- and diglycerides of edible fatty acids, lactic acid esters and acetic acid esters of mono- and diglycerides of edible fatty acids, acetylated mono and diglycerides, sugar esters of edible fatty acids, Na-, K-, Mg- and Ca-stearates, lecithin, hydroxylated lecithin and the like are examples of conventionally used emulsifiers which can be added to the chewing gum base. In case of the presence of a biologically or pharmaceutically active ingredient as defined below, the formulation may comprise certain specific emulsifiers and/or solubilisers in order to disperse and release the active ingredient.

Waxes and fats are conventionally used for the adjustment of the consistency and for softening of the chewing gum base when preparing chewing gum bases. In connection with the present invention, any conventionally used and suitable type of wax and fat may be used, such as for instance rice bran wax, polyethylene wax, petroleum wax (refined paraffin and microcrystalline wax), paraffin, beeswax, carnauba wax, candelilla wax, cocoa butter, degreased cocoa powder and any suitable oil or fat, as e.g. completely or partially hydrogenated vegetable oils or completely or partially hydrogenated animal fats.

In an embodiment of the invention, the chewing gum comprises filler.

A chewing gum base formulation may, if desired, include one or more fillers/texturisers including as examples, magnesium and calcium carbonate, sodium sulphate, ground limestone, silicate compounds such as magnesium and aluminum silicate, kaolin and clay, aluminum oxide, silicium oxide, talc, titanium oxide, mono-, di- and tri-calcium phosphates, cellulose polymers, such as wood, and combinations thereof.

In an embodiment of the invention, the chewing gum comprises filler in an amount of about 0 to about 50% by weight of the chewing gum, more typically about 10 to about 40% by weight of the chewing gum.

In addition to a water insoluble gum base portion, a typical chewing gum includes a water soluble bulk portion and one or more flavoring agents. The water-soluble portion may include bulk sweeteners, high intensity sweeteners, flavoring agents, softeners, emulsifiers, colors, acidulants, fillers, antioxidants, and other components that provide desired attributes.

According to provisions of the invention the chewing gum may contain different kinds of sweeteners.

Suitable bulk sweeteners include both sugar and non-sugar sweetening components. Bulk sweeteners typically constitute from about 5 to about 95% by weight of the chewing gum, more typically about 20 to about 80% by weight such as 30 to 60% by weight of the gum.

Useful sugar sweeteners are saccharide-containing components commonly known in the chewing gum art including, but not limited to, sucrose, dextrose, maltose, dextrins, trehalose, D-tagatose, dried invert sugar, fructose, levulose, galactose, corn syrup solids, and the like, alone or in combination.

Sorbitol can be used as a non-sugar sweetener. Other useful non-sugar sweeteners include, but are not limited to, other sugar alcohols such as mannitol, xylitol, hydrogenated starch hydrolysates, maltitol, isomalt, erythritol, lactitol and the like, alone or in combination.

High-intensity artificial sweetening agents can also be used alone or in combination with the above sweeteners. Preferred high-intensity sweeteners include, but are not limited to sucralose, aspartame, salts of acesulfame, alitame, neotame, twinsweet, saccharin and its salts, cyclamic acid and its salts, glycyrrhizin, dihydrochalcones, thaumatin, monellin, stevioside and the like, alone or in combination. In order to provide longer lasting sweetness and flavor perception, it may be desirable to encapsulate or otherwise control the release of at least a portion of the artificial sweetener. Techniques such as wet granulation, wax granulation, spray drying, spray chilling, fluid bed coating, coascervation, encapsulation in yeast cells and fiber extrusion may be used to achieve the desired release characteristics. Encapsulation of sweetening agents can also be provided using another chewing gum component such as a resinous compound.

Usage level of the high intensity artificial sweetener will vary considerably and will depend on factors such as potency of the sweetener, rate of release, desired sweetness of the product, level and type of flavor used and cost considerations. Thus, the active level of high potency artificial sweetener may vary from about 0 to about 8% by weight, preferably 0.001 to about 5% by weight. When carriers used for encapsulation are included, the usage level of the encapsulated sweetener will be proportionately higher.

Combinations of sugar and/or non-sugar sweeteners can be used in the chewing gum formulation processed in accordance with the invention. Additionally, the softener may also provide additional sweetness such as aqueous sugar or alditol solutions.

If a low-calorie gum is desired, a low-caloric bulking agent can be used. Examples of low caloric bulking agents include polydextrose, Raftilose, Raftilin, fructooligosaccharides (NutraFlora®), palatinose oligosaccharides; guar gum hydrolysates (e.g. Sun Fiber®) or indigestible dextrins (e.g. Fibersol®). However, other low-calorie bulking agents can be used.

According to provisions of the invention the chewing gum may contain different kinds of flavors.

The chewing gum according to the present invention may contain aroma agents and flavoring agents including natural and synthetic flavorings e.g. in the form of natural vegetable components, essential oils, essences, extracts, powders, including acids and other substances capable of affecting the taste profile. Examples of liquid and powdered flavorings include coconut, coffee, chocolate, vanilla, grape fruit, orange, lime, menthol, liquorice, caramel aroma, honey aroma, peanut, walnut, cashew, hazelnut, almonds, pineapple, strawberry, raspberry, tropical fruits, cherries, cinnamon, peppermint, wintergreen, spearmint, eucalyptus, and mint, fruit essence such as from apple, pear, peach, strawberry, apricot, raspberry, cherry, pineapple, and plum essence. The essential oils include peppermint, spearmint, menthol, eucalyptus, clove oil, bay oil, anise, thyme, cedar leaf oil, nutmeg, and oils of the fruits mentioned above.

The chewing gum flavor may be a natural flavoring agent, which is freeze-dried, preferably in the form of a powder, slices or pieces or combinations thereof. The particle size may be less than 3 mm, less than 2 mm or more preferred less than 1 mm, calculated as the longest dimension of the particle. The natural flavoring agent may in a form where the particle size is from about 3 μm to 2 mm, such as from 4 μm to 1 mm. Preferred natural flavoring agents include seeds from fruit e.g. from strawberry, blackberry and raspberry.

Various synthetic flavors, such as mixed fruit flavors may also be used in the present chewing gum centers. As indicated above, the aroma agent may be used in quantities smaller than those conventionally used. The aroma agents and/or flavors may be used in the amount from 0.01 to about 30% by weight of the final product depending on the desired intensity of the aroma and/or flavor used. Preferably, the content of aroma/flavor is in the range of 0.2 to 3% by weight of the total composition.

In an embodiment of the invention, the flavoring agents comprise natural and synthetic flavorings in the form of natural vegetable components, essential oils, essences, extracts, powders, including acids and other substances capable of affecting the taste profile.

Further chewing gum ingredients, which may be included in the chewing gum according to the present invention, include surfactants and/or solubilisers, especially when pharmaceutically or biologically active ingredients are present. As examples of types of surfactants to be used as solubilisers in a chewing gum composition according to the invention, reference is made to H. P. Fiedler, Lexikon der Hilfstoffe für Pharmacie, Kosmetik and Angrenzende Gebiete, pages 63-64 (1981) and the lists of approved food emulsifiers of the individual countries. Anionic, cationic, amphoteric or non-ionic solubilisers can be used. Suitable solubilisers include lecithin, polyoxyethylene stearate, polyoxyethylene sorbitan fatty acid esters, fatty acid salts, mono and diacetyl tartaric acid esters of mono and diglycerides of edible fatty acids, citric acid esters of mono and diglycerides of edible fatty acids, saccharose esters of fatty acids, polyglycerol esters of fatty acids, polyglycerol esters of interesterified castor oil acid (E476), sodium stearoyllatylate, sodium lauryl sulfate and sorbitan esters of fatty acids and polyoxyethylated hydrogenated castor oil (e.g. the product sold under the trade name CREMOPHOR), block copolymers of ethylene oxide and propylene oxide (e.g. products sold under trade names PLURONIC and POLOXAMER), polyoxyethylene fatty alcohol ethers, polyoxyethylene sorbitan fatty acid esters, sorbitan esters of fatty acids and polyoxyethylene steraric acid esters.

Particularly suitable solubilisers are polyoxyethylene stearates, such as for instance polyoxyethylene(8)stearate and polyoxyethylene(40)stearate, the polyoxyethylene sorbitan fatty acid esters sold under the trade name TWEEN, for instance TWEEN 20 (monolaurate), TWEEN 80 (monooleate), TWEEN 40 (monopalmitate), TWEEN 60 (monostearate) or TWEEN 65 (tristearate), mono and diacetyl tartaric acid esters of mono and di-glycerides of edible fatty acids, citric acid esters of mono and diglycerides of edible fatty acids, sodium stearoyllatylate, sodium laurylsulfate, polyoxyethylated hydrogenated castor oil, blockcopolymers of ethylene oxide and propyleneoxide and polyoxyethylene fatty alcohol ether. The solubiliser may either be a single compound or a combination of several compounds. In the presence of an active ingredient, the chewing gum may preferably also comprise a carrier known in the art.

Emulsifiers, which are used as softeners may include tallow, hydrogenated tallow, hydrogenated and partially hydrogenated vegetable oils, cocoa butter, glycerol monostearate, glycerol triacetate, lechithin, mono-, di- and triglycerides, acetylated monoglycerides, fatty acids (e.g. stearic, palmitic, oleic and linoleic acids), and combinations thereof.

According to an embodiment of the invention, the chewing gum may comprise a pharmaceutically, cosmetically or biologically active substance. Examples of such active substances, a list of which is found e.g. in WO 00/25598, which is incorporated herein by reference, are given below.

The active agents to be used in connection with the present invention may be any substance desired to be released from the chewing gum. If an accelerated rate of release is desired, corresponding to the effect obtained for the flavor, the primary substances are those with limited water solubility, typically below 10 g/100 ml including substances which are entirely water insoluble. Examples are antihistamines, anti-smoking agents, agents used for diabetes, decongestrants, peptides, pain-relieving agents, antacids, nausea-relieving agents, statines, medicines, dietary supplements, oral compositions, anti-smoking agents, highly potent sweeteners, pH adjusting agents, etc.

Further examples of active ingredients include acyclovir, flour, flour in combination with fruit acids, chlorhexidine and any derivatives thereof, salts thereof and isomers thereof, benzydamin, rimonabant, varenicline, sildenafil and naltrexone.

Furthermore, reference is made to lists of nutrients accepted by the authorities in different countries such as for instance US code of Federal Regulations, Title 21, Section 182.5013.182 5997 and 182.8013-182.8997.

Examples of active agents in the form of compounds for the care or treatment of the oral cavity and the teeth are for instance bound hydrogen peroxide and compounds capable of releasing urea during chewing. Cf. furthermore J. Dent. Res. Vol. 28 No. 2, page 160-171, 1949, wherein a wide range of tested compounds is mentioned.

Examples of active agents in the form of agents adjusting the pH in the oral cavity include for instance: acceptable acids, such as adipinic acid, succinic acid, fumaric acid, or salts thereof or salts of citric acid, tartaric acid, malic acid, acetic acid, lactic acid, phosphoric acid and glutaric acid and acceptable bases, such as carbonates, hydrogen carbonates, phosphates, sulfates or oxides of sodium, potassium, ammonium, magnesium or calcium, especially magnesium and calcium.

Examples of active agents in the form of anti-smoking agents include for instance: nicotine, nicotine bitartrate, nicotine polacrilex, nicotine in combination with alkaline agents, nicotine in combination with caffeine, nicotine antagonists, combinations thereof or compounds comprising one or more of these.

Further examples of active agents are medicines of any type.

Examples of active agents in the form of medicines include ceterizine, levo ceterezine, loratadine, des-loratadine, metformine, metformin HCl, phenylephrine, pseudoephedrine, fluorbiprofene, paracetamol, acetylsalicylic acid, ibuprofene, cimetidine, ranitidine, ondansetron, granisetron, metoclopramid, simvastatin. lovastatin and fluvastatin.

In one embodiment of the invention, the flavor may be used as taste masking in chewing gum comprising active ingredients, which by themselves have undesired taste or which alter the taste of the formulation.

The chewing gum may optionally contain usual additives, such as binding agents, acidulants, fillers, coloring agents, preservatives, and antioxidants, for instance butylated hydroxytoluene (BHT), butyl hydroxyanisol (BHA), propylgallate and tocopherols.

Colorants and whiteners may include FD & C-type dyes and lakes, fruit and vegetable extracts, titanium dioxide, and combinations thereof.

Materials to be used for the above-mentioned encapsulation methods for sweeteners might e.g. include Gelatine, Wheat protein, Soya protein, Sodium caseinate, Caseine, Gum arabic, Mod. starch, Hydrolyzed starches (maltodextrines), Alginates, Pectin, Carregeenan, Xanthan gum, Locus bean gum, Chitosan, Bees wax, Candelilla wax, Carnauba wax, Hydrogenated vegetable oils, Zein and/or Sucrose.

Generally, it is preferred that the chewing gum and the gum bases prepared according to the invention are based solely on biodegradable polymers.

However, within the scope of the invention, minor amounts of conventional synthetic chewing gum elastomers or elastomer plasticizers, examples of which are mentioned below, may be applied.

Examples of such generally non-biodegradable synthetic resins include polyvinyl acetate, vinyl acetate-vinyl laurate copolymers and mixtures thereof. Examples of non-biodegradable synthetic elastomers include, but are not limited to, synthetic elastomers listed in Food and Drug Administration, CFR, Title 21, Section 172,615, the Masticatory Substances, Synthetic) such as polyisobutylene. e.g. having a gel permeation chromatography (GPC) average molecular weight in the range of about 10,000 to 1,000,000 including the range of 50,000 to 80,000, isobutylene-isoprene copolymer (butyl elastomer), styrene-butadiene copolymers e.g. having styrene-butadiene ratios of about 1:3 to 3:1, polyvinyl acetate (PVA), e.g. having a GPC average molecular weight in the range of 2,000 to 90,000 such as the range of 3,000 to 80,000 including the range of 30,000 to 50,000, where the higher molecular weight polyvinyl acetates are typically used in bubble gum base, polyisoprene, polyethylene, vinyl acetate-vinyl laurate copolymer e.g. having a vinyl laurate content of about 5 to 50% by weight such as 10 to 45% by weight of the copolymer, and combinations hereof.

It is common in the industry to combine in a gum base a synthetic elastomer having a high molecular weight and a synthetic elastomer having a low molecular weight. Examples of such combinations of are polyisobutylene and styrene-butadiene, polyisobutylene and polyisoprene, polyisobutylene and isobutylene-isoprene copolymer (butyl rubber) and a combination of polyisobutylene, styrene-butadiene copolymer and isobutylene isoprene copolymer, and all of the above individual synthetic polymers in admixture with polyvinyl acetate, vinyl acetate-vinyl laurate copolymers, respectively and mixtures thereof.

Examples of natural resins, which should preferably not be applied in the chewing gum according to the present invention are: Natural rosin esters, often referred to as ester gums including as examples glycerol esters of partially hydrogenated rosins, glycerol esters of polymerised rosins, glycerol esters of partially dimerized rosins, glycerol esters of tally oil rosins, pentaerythritol esters of partially hydrogenated rosins, methyl esters of rosins, partially hydrogenated methyl esters of rosins, pentaerythritol esters of rosins, synthetic resins such as terpene resins derived from alpha-pinene, beta-pinene, and/or d-limonene, and natural terpene resins.

In general, chewing gum may be manufactured by sequentially adding the various chewing gum ingredients to a commercially available mixer known in the art. After the initial ingredients have been thoroughly mixed, the chewing gum mass is discharged from the mixer and shaped into the desired form such as by rolling into sheets and cutting into sticks, extruded into chunks or casting into pellets.

Generally, the ingredients may be mixed by first melting the gum base and adding it to the running mixer. Colors, active agents and/or emulsifiers may also be added at this time. A softener such as glycerin may also be added at this time, along with syrup and a portion of the bulking agent/sweetener. Further portions of the bulking agent/sweetener may then be added to the mixer. A flavoring agent is typically added with the final portion of the bulking agent/sweetener. A high-intensity sweetener is preferably added after the final portion of bulking agent and flavor has been added.

The entire mixing procedure typically takes from five to fifteen minutes, but longer mixing times may sometimes be required. Those skilled in the art will recognize that many variations of the above described procedure may be followed. Including the one-step method described in US patent application 2004/0115305 hereby incorporated as reference. Chewing gums are formed by extrusion, compression, rolling and may be centre filled with liquids and/or solids in any form.

Compression techniques applicable in connection with the polymer according to the provisions of the invention include, but are not limited to EP 1 427 292 describing a way of obtaining gum granules, hereby included by reference.

Formation of gum granules by extrusion may e.g. be established according to WO 2004/098307 and WO 2004/098305 hereby included by reference.

Moreover, the invention may be applied in connection with attractive compression formulations as described in PCT/IB2007/001902, PCT/IB2007/001898, PCT/IB2007/001907, PCT/IB2007/001900, PCT/IB2007/001899, EP1517617, EP1589825, EP1523241 and EP1765304, hereby included by reference.

The chewing gum according to the present invention may also be provided with an outer coating, which may be a hard coating, a soft coating, a film coating, or a coating of any type that is known in the art, or a combination of such coatings. The coating may typically constitute 0.1 to 75 percent by weight of a coated chewing gum piece.

One preferred outer coating type is a hard coating, which term is including sugar coatings and sugar-free (or sugarless) coatings and combinations thereof. The object of hard coating is to obtain a sweet, crunchy layer, which is appreciated by the consumer and to protect the gum centers. In a typical process of providing the chewing gum centers with a protective sugar coating the gum centers are successively treated in suitable coating equipment with aqueous solutions of crystallizable sugar such as sucrose or dextrose, which, depending on the stage of coating reached, may contain other functional ingredients, e.g. fillers, colors, etc.

In one presently preferred embodiment, the coating agent applied in a hard coating process is a sugarless coating agent, e.g. a polyol including as examples sorbitol, maltitol, mannitol, xylitol, erythritol, lactitol and isomalt or e.g. a mono-di-saccharide including as example trehalose.

Or alternatively a sugar free soft coating e.g. comprising alternately applying to the centres a syrup of a polyol or a mono-di-saccharide, including as examples sorbitol, maltitol, mannitol, xylitol, erythritol, lactitol, isomalt and trehalose.

In further useful embodiments a film coating is provided by film-forming agents such as a cellulose derivative, a modified starch, a dextrin, gelatine, zein, shellec, gum arabic, a vegetable gum, a synthetic polymer, etc. or a combination thereof.

In an embodiment of the invention, the outer coating comprises at least one additive component selected from the group comprising of a binding agent, a moisture-absorbing component, a film-forming agent, a dispersing agent, an antisticking component, a bulking agent, a flavoring agent, a coloring agent, a pharmaceutically or cosmetically active component, a lipid component, a wax component, a sugar, an acid.

A coated chewing gum center according to the invention may have any form, shape or dimension that permits the chewing gum center to be coated using any conventional coating process.

The gum centre of coated chewing gum element according to the invention can have any form, shape or dimension that permits the chewing gum centre to be coated using any conventional coating process. Accordingly, the gum centre may be e.g. in a form selected from a pellet, a cushion-shaped pellet, a stick, a tablet, a chunk, a pastille, a pill, a ball and a sphere, and typically the weight of a gum center may be 0.5 to 5 grams.

The following non-limiting examples illustrate the manufacturing of a chewing gum according to the invention.

### Example 1

### Preparation of Polyester by Condensation Polymerization

A polyester was prepared from 1608 g of adipic acid (11.0 mol), 1005 g of 1,2-propanediol (13.2 mol) and 30.7 g of glycerol (0.33 mol).

The polymer was prepared by known methods described in f.x. Encyclopedia of Polymer Science and Engineering, Vol. 12, 2^{nd}. ed., John Wiley & Sons, 1988, p. 1-75.

The polymer was prepared by similar means as those described in WO2004/096886.

The polymer obtained had a VN of 254 mL/g and a Tg of −37° C.

### Example 2

### Preparation of Polyester by Condensation Polymerization

A polyester was prepared from 1535 g of succinic acid (13.0 mol), 331 g of diethylene glycol (3.1 mol), 950 g of 1,2-propanediol (12.5 mol) and 32.2 g of glycerol (0.35 mol).

The polymer was prepared by known methods described in f.x. Encyclopedia of Polymer Science and Engineering, Vol. 12, 2^{nd}. ed., John Wiley & Sons, 1988, p. 1-75 and by similar means as those described in WO2004/096886.

The polymer obtained had a VN of 160 mL/g and a Tg of −10° C.

### Example 3

### Preparation of Polyester by Condensation Polymerization

A polyester was prepared from 249 g of terephthalic acid (1.5 mol), 1242 g of adipic acid (8.5 mol), 1272 g of diethylene glycol (12.0 mol) and 33.7 g of glycerol (0.37 mol).

The polymer was prepared by known methods described in f.x. Encyclopedia of Polymer Science and Engineering, Vol. 12, 2^{nd}. ed., John Wiley & Sons, 1988, p. 1-75 and as described in US2007/0043200 and in Tsai et al., Polymer 1990, 31, 1589.

### Example 4

### Preparation of Polyester by Condensation Polymerization

A polyester was prepared from 1299 g of succinic acid (11.0 mol), 1518 g of diethylene glycol (14.3 mol), and 31.1 g of glycerol (0.34 mol). Tetrabutylorthotitanate (0.16 ml) was used as catalyst.

The polymer was prepared by known methods described in f.x. Encyclopedia of Polymer Science and Engineering, Vol. 12, 2^{nd}. ed., John Wiley & Sons, 1988, p. 1-75 and as described in US2007/0043200 and in Tsai et al., Polymer 1990, 31, 1589.

The polymer obtained had a VN of 214 mL/g and a Tg of −24° C.

### Example 5

### Preparation of Polyester by Condensation Polymerization

A polyester was prepared from 1535 g of succinic acid (13.0 mol), 331 g of diethylene glycol (3.12 mol), 950 g of 1,2-propanediol (10.3 mol) and 32.2 g of glycerol (0.35 mol). Tetrabutylorthotitanate (0.16 ml) was used as catalyst.

The polymer was prepared by known methods described in f.x. Encyclopedia of Polymer Science and Engineering, Vol. 12, 2^{nd}. ed., John Wiley & Sons, 1988, p. 1-75 and as described in US2007/0043200 and in Tsai et al., Polymer 1990, 31, 1589.

The polymer obtained had a VN of 350 mL/g.

### Example 6

### Preparation of Polyester by Condensation Polymerization

A polyester was prepared from 1535 g of succinic acid (13.0 mol), 331 g of diethylene glycol (3.12 mol), 950 g of 1,2-propanediol (10.3 mol) and 10.7 g of glycerol (0.12 mol). Tetrabutylorthotitanate (0.16 ml) was used as catalyst.

The polymer was prepared by known methods described in f.x. Encyclopedia of Polymer Science and Engineering, Vol. 12, 2^{nd}. ed., John Wiley & Sons, 1988, p. 1-75 and as described in US2007/0043200 and in Tsai et al., Polymer 1990, 31, 1589.

### Example 7

### Preparation of Polyester by Condensation Polymerization

A polyester was prepared from 1535 g of succinic acid (13.0 mol), 331 g of diethylene glycol (3.12 mol), 950 g of 1,2-propanediol (10.3 mol) and 64.2 g of glycerol (0.70 mol). Tetrabutylorthotitanate (0.16 ml) was used as catalyst.

The polymer was prepared by known methods described in f.x. Encyclopedia of Polymer Science and Engineering, Vol. 12, 2^{nd}. ed., John Wiley & Sons, 1988, p. 1-75 and as described in US2007/0043200 and in Tsai et al., Polymer 1990, 31, 1589.

### Example 8

### Polyester Prepared by Ring-Opening Polymerization

A homopolymer by NatureWorks PLA 4060 D (amorph) poly D,L-lactide was provided as a resin. The homopolymer has a Tg of about 56° C. (Mn ˜100,000).

### Example 9

### Polyester Prepared by Ring-Opening Polymerization

A homopolymer by NatureWorks PLA 5500 D (amorph) poly D,L-lactide was provided as a resin. The homopolymer has a Tg of about 50° C. (Mn˜50,000).

### Example 10

### Preparation of Biodegradable Resinous Polymer with Molar Ratio of 97% D,L-Lactide and 3% ε-Caprolactone Initiated with 1,2-Propane Diol

To a dry 100 ml glass round-bottom flask was charged 0.265 g Tin(II)-ethylhexanoate (Aldrich 97%), 6.427 g 1,2-propanediol (Aldrich 99+%), and 18.627 g ε-caprolactone (ACROS 99-F %) in a dry, nitrogen purged glove-box. The reactor was immersed into a 130° C. preheated silicone oil bath and mechanically stirred for 65 minutes and removed from the oil bath. The polymer was drawn into a dry syringe while still hot and 22.172 g was charged into a dry 1000 ml round-bottom flask containing 678.062 g D,L-lactide (ORTEC). The flask was immersed into the 130° C. preheated silicone oil bath and mechanically stirred for 300 minutes when removed. The flask was immediately removed from the glove-box and completely wrapped with a pre-heated Glas-Col 500 watts/115 volts heating mantle regulated with a Staco Energy Products Type 3 Variable Autotransformer set at 65% of 0-120V output. The heated vessel was inverted allowing the final polymer product to fully discharge from the reactor within approximately 2 minutes into a dry 1-quart metal packaging container.

Characterization of the polymer indicates Tg=44° C. (DSC, heating rate 10° C./min), Mₙ=11,650 g/mol, and M_{w}=12,420 g/mol (gel permeation chromatography with online MALLS detector). PD=1.07.

### Example 11

### Preparation of Biodegradable Resinous Polymer with Molar Ratio of 96.5% D,L-Lactide and 3.5% ε-Caprolactone Initiated with 1,2-Propane Diol

To a dry 100 ml glass round-bottom flask was charged 0.252 g Tin(11)-ethylhexanoate (Aldrich 97%), 3.198 g 1,2-propanediol (Aldrich 99+%), and 23.366 g ε-caprolactone (ACROS 99-F %) in a dry, nitrogen purged glove-box. The reactor was immersed into a 130° C. preheated silicone oil bath and mechanically stirred for 65 minutes and removed from the oil bath. The polymer was drawn into a dry syringe while still hot and 22.344 g was charged into a dry 1000 ml round-bottom flask containing 677.871 g D,L-lactide (ORTEC). The flask was immersed into the 130° C. preheated silicone oil bath and mechanically stirred for 320 minutes when removed. The flask was immediately removed from the glove-box and completely wrapped with a pre-heated Glas-Col 500 watts/115 volts heating mantle regulated with a Staco Energy Products Type 3 Variable Autotransformer set at 65% of 0-120V output. The heated vessel was inverted allowing the final polymer product to fully discharge from the reactor within approximately 2 minutes into a dry 1-quart metal packaging container.

Characterization of the polymer indicates Tg=41° C. (DSC, heating rate 10° C./min), Mn=20,350 g/mol, and Mw=23,480 g/mol (gel permeation chromatography with online MALLS detector). PD=1.15.

### Example 12

### Biodegradable Resinous Polymer with Lower Tg

A polymerization similar to example 7 was performed to prepare a biodegradable resinous polymer with molar ratio of 91.5% D,L-lactide and 8.5% ε-caprolactone.

Characterization of the polymer indicates Tg=31° C. (DSC, heating rate 10° C./min), Mn=6500 g/mol, and Mw=7600 g/mol.

### Example 13

### Biodegradable Resinous Homo-Polymer with a Higher Tg

A polymerization similar to example 7 was performed to prepare a biodegradable resinous polymer polymerized from only one monomer type, D,L-lactide to make a 100%-lactide-based polymer.

Characterization of the polymer indicates Tg about 40-45° C. (DSC, heating rate 10° C./min), Mn=6,800 g/mol and Mw=7,400 g/mol (gel permeation chromatography with online MALLS detector).

### Example 14

### Preparation of Gum Bases

Gum bases are prepared with formulations as outlined in table 1 and table 2:

TABLE 1
Gum base formulations. The components are given in percent by weight of the gum base.

| | Gum base no. | | | | | | | | | | | | |
|---|---|---|---|---|---|---|---|---|---|---|---|---|---|
| Components | 101 | 102 | 103 | 104 | 105 | 106 | 107 | 108 | 109 | 110 | 111 | 112 | 113 |
| Polymer of Example 1 | 60 | 60 | 60 | 60 | 60 | 60 | 60 | 60 | 100 | 55 | | | |
| Polymer of Example 2 | | | | | | | | | | | 60 | | |
| Polymer of Example 3 | | | | | | | | | | | | 60 | 60 |
| Polyvinyl acetate | | | | | | | 40 | | | | | | |
| Zein hydrolysate | | | | | | | | 40 | | | | | |
| Polymer of Example 8 | 40 | | | | | | | | | 35 | 40 | 40 | |
| Polymer of Example 9 | | 40 | | | | | | | | | | | |
| Polymer of Example | | | 40 | | | | | | | | | | |
| 10 | | | | | | | | | | | | | |
| Polymer of Example | | | | 40 | | | | | | | | | |
| 11 | | | | | | | | | | | | | |
| Polymer of Example | | | | | 40 | | | | | 10 | | | 40 |
| 12 | | | | | | | | | | | | | |
| Polymer of Example | | | | | | 40 | | | | | | | |
| 13 | | | | | | | | | | | | | |

TABLE 2
Gum base formulations. The components are given in percent by weight of the gum base.

| | Gum base no. | | | | | | | | | | | | |
|---|---|---|---|---|---|---|---|---|---|---|---|---|---|
| Components | 114 | 115 | 116 | 117 | 118 | 119 | 120 | 121 | 122 | 123 | 124 | 125 | 126 |
| Polymer of Example 1 | 25 | 25 | 25 | 25 | 25 | 25 | 45 | 55 | 40 | 45 | | | |
| Polymer of Example 2 | | | | | | | | | | | 25 | | |
| Polymer of Example 3 | | | | | | | | | | | | 40 | 25 |
| Polymer of Example 8 | 30 | | | | | | 10 | | | | 30 | 20 | |
| Polymer of Example 9 | | 30 | | | | | | | | | | | 10 |
| Polymer of Example | | | 30 | | | | | | | | | | |
| 10 | | | | | | | | | | | | | |
| Polymer of Example | | | | 30 | | | | | 20 | | | | |
| 11 | | | | | | | | | | | | | |
| Polymer of Example | | | | | 30 | | | | | 20 | | | 20 |
| 12 | | | | | | | | | | | | | |
| Polymer of Example | | | | | | 30 | | | | | | | |
| 13 | | | | | | | | | | | | | |
| Filler | 20 | 20 | 20 | 20 | 20 | 20 | 20 | 20 | 15 | 10 | 20 | 15 | 20 |
| Emulsifier | 5 | 5 | 5 | 5 | 5 | 5 | 5 | 5 | 5 | 5 | 5 | 5 | 5 |
| Fat | 20 | 20 | 20 | 20 | 20 | 20 | 20 | 20 | 20 | 20 | 20 | 20 | 20 |

The gum bases no. 103-105, 107-109, 113, 116-118, and 121-123 are prepared as follows:

The polymers are added to a mixing kettle provided with mixing means like e.g. horizontally placed Z-shaped arms. The kettle has been preheated for 15 minutes to a temperature of about 60-80° C. The mixture is mixed for 10-20 minutes until the whole mixture becomes homogeneous. The mixture is then discharged into the pan and allowed to cool to room temperature from the discharged temperature of 60-80° C.

The gum bases no. 101-102, 106, 110-112, 114-115, 119-120 and 124-126 are prepared as follows:

The gum base components are added to a mixing kettle provided with mixing means like e.g. horizontally placed Z-shaped arms. The kettle has been preheated to a temperature of about 110-140° C. The mixture is mixed for 30-120 minutes until the whole mixture becomes homogeneous. The mixture is then discharged into the pan and allowed to cool to room temperature.

Further gum bases may be prepared with formulations corresponding to gum bases no. 101-126 by substituting the polymer of Example 1 with any of the polymers of Examples 2-3. These further gum bases may be prepared for application corresponding to the application of gum bases no. 101-126 in chewing gum prepared according to the below Example 15.

### Example 15

### Preparation of Chewing Gum

The gum bases of Example 14 are applied in chewing gum prepared with the formulations as outlined in table 2:

TABLE 2
Chewing gum formulation in which % denotes
percent by weight of the chewing gum.

Chewing gum no.

| Components | 1001-1013 | 1014-1026 |
|---|---|---|
| Gum base | 27% | 40 |
| Sorbitol | 49.6% | 42.6 |
| Xylitol | 6% | 6 |
| Filler | 5% | — |
| Wax | 4% | — |
| Softener | 2% | — |
| Maltitol syrup | 3% | 9 |
| Peppermint | 1.5% | 1.5 |
| Emulsifier | 1% | — |
| Menthol crystals | 0.5% | 0.5 |
| Aspartame | 0.2% | 0.2 |
| Acesulfame | 0.2% | 0.2 |

Each chewing gum no. 1001 to 1026 is produced with a content of gum base no. 101 to 126, respectively. In other words, gum base no. 101 is applied in the preparation of chewing gum no. 1001, and gum base no. 102 is applied in the preparation of chewing gum no. 1002, and so forth.

As regards chewing gum no. 1001-1013, the softeners, emulsifiers and fillers may alternatively be added to the polymers as a part of the gum base preparation.

The chewing gum products no. 1001-1013 are prepared as follows:

The gum base is added to a mixing kettle provided with mixing means like e.g. horizontally placed Z-shaped arms. The kettle has been preheated for 15 minutes to a temperature of about 40-60° C. or the chewing gum is made in one step, immediately after preparation of gum base in the same mixer where the gum base and kettle has a temperature of about 60-80° C.

One half portion of the sorbitol is added together with the gum base and mixed for 3 minutes. Peppermint and menthol are then added to the kettle and mixed for 1 minute. The remaining half portion of sorbitol is added and mixed for 1 minute. Maltitol syrup is added, and then wax and filler may be added and the gum mass is mixed well for 3 minutes. Softeners and emulsifiers are slowly added and mixed for 4 minutes. Then aspartame and acesulfame are added to the kettle and mixed for 3 minutes. Xylitol is added and mixed for 3 minutes. The resulting gum mixture is then discharged and e.g. transferred to a pan at a temperature of 40-48° C. The gum is then rolled and scored into cores, sticks, balls, cubes, and any other desired shape, optionally followed by coating and polishing processes prior to packaging.

Evidently, within the scope of the invention, other processes and ingredients may be applied in the process of manufacturing the chewing gum. In particular, the final chewing gum products may be prepared as tabletted chewing gum by a compression technique.

The chewing gum products no. 1013-1026 are prepared as follows:

The gum base is added to a mixing kettle provided with mixing means like e.g. horizontally placed Z-shaped arms. The kettle has been preheated for 15 minutes to a temperature of about 40-60° C. or the chewing gum is made in one step, immediately after preparation of gum base in the same mixer where the gum base and kettle has a temperature of about 60-80° C.

One half portion of the sorbitol is added together with the gum base and mixed for 3 minutes. Peppermint and menthol are then added to the kettle and mixed for 1 minute. The remaining half portion of sorbitol is added and mixed for 1 minute. Maltitol syrup is added, and the gum mass is mixed well for 3 minutes. Then aspartame and acesulfame are added to the kettle and mixed for 3 minutes. Xylitol is added and mixed for 3 minutes. The resulting gum mixture is then discharged and e.g. transferred to a pan at a temperature of 40-48° C. The gum is then rolled and scored into cores, sticks, balls, cubes, and any other desired shape, optionally followed by coating and polishing processes prior to packaging.

Evidently, within the scope of the invention, other processes and ingredients may be applied in the process of manufacturing the chewing gum. In particular, the final chewing gum products may be prepared as tabletted chewing gum by a compression technique.

### Example 16

### Degradation Evaluation

3 pieces of chewed chewing gum of each composition 1001, 1011, 1012 and a conventional non-degradable composition were mixed with compost and stored at 55° C. and 96% RH for five weeks.

On visual inspection after five weeks, the gums of compositions 1001 and 1011 were considerably more affected (degraded) than the gums of composition 1012.

This is at least partly due to the aromatic content of composition 1012 leaving the gum base more stable towards biodegradation. It has to be kept in mind, however, that other chewing gum ingredients have to be degraded as well and based on the above evaluation, the bio-accessibillity for degradation of these ingredients seems to be enhanced by use of gum bases 101 and 111 when compared to gum base 112. Nevertheless, the non-biodegradable composition was still less affected (degraded) than composition 1012, showing that even with some aromatic content, the polymers comprised in the chewing gum of the present invention are considered degradable when compared to conventional chewing gum polymers.

### Example 17

### Evaluation

By means of chewing evaluations, it has been established that the above chewing gums provide an acceptable release of sweetening agent when applying sweetening agents in the ranges typically applied in connection with conventional chewing gum. Of even more interest is that the chewing gum obtained inherits attractive textural properties resembling those of conventional chewing gum.

It has moreover been established that filler may be applied in ranges also typically applied in connection with conventional chewing gum.

What is claimed is:

1. A chewing gum comprising at least one polyester polymer, said polyester polymer consisting of the following polyester-forming components in condensed form:
a) at least one dicarboxylic acid,
b) at least one diol,
c) at least one compound having at least three groups capable of ester formation,
wherein the polyester polymer comprises the components a) and b) in an amount of at least 90% by weight based on a total weight of the polyester polymer, and wherein the molar ratio between aromatic acids and aliphatic acids of said dicarboxylic acid in the chewing gum is between 0 and 1:4.2.

2. The chewing gum according to claim 1, wherein the polyester polymer is prepared by step-growth polymerization.

3. The chewing gum according to claim 1, wherein the at least one polyester polymer has a molecular weight (Mw) of at least 20,000 g/mol.

4. The chewing gum according to claim 1, wherein the at least one polyester polymer has a molecular weight (Mw) of at least 40,000 g/mol.

5. The chewing gum according to claim 1, wherein the dicarboxylic acid comprises α,ω-alkane dicarboxylic acid having from 4 to 12 carbon atoms.

6. The chewing gum according to claim 1, wherein the diol comprises an aliphatic diol having at least one branching point, a saturated cyclic structure and/or at least one ether group.

7. The chewing gum according to claim 1, wherein the diol comprises propane-1,2-diol, propane-1,3-diol, 2,2-dimethylpropane-1,3-diol, diethylene glycol, triethylene glycol, tetraethylene glycol or 1,4-cyclohexanedimethanol.

8. The chewing gum according to claim 1, wherein the polyester contains the components a) and b) in a molar ratio a):b) of from 0.95:1 to 1.05:1.

9. The chewing gum according to claim 1, wherein the compound having at least three groups of ester formation comprises tartaric acid, citric acid, malic acid, trimethylolpropane, trimethylolethane, pentaerythritol, polyethertriols, glycerol, trimesic acid, trimellitic acid, pyromellitic acid or hydroxyisolphthalic acid.

10. The chewing gum according to claim 1, wherein the polyester contains the components c) in an amount of from 1.0 to 10.0% by weight based on the total weight of the polyester.

11. The chewing gum according to claim 1, wherein the polyester contains the components c) in an amount of from 1.0 to 5.0% by weight based on the total weight of the polyester.

12. The chewing gum according to claim 1, wherein the molar ratio between aromatic acids and aliphatic acids of said dicarboxylic acid in the chewing gum is between 1:100 and 1:5.

13. A chewing gum comprising at least one polyester polymer, said polyester polymer having free active ends and comprising as polyester-forming components in condensed form:
a) at least one dicarboxylic acid,
b) at least one diol,
c) at least one compound having at least three groups capable of ester formation,
wherein the polyester polymer comprises the components a) and b) in an amount of at least 90% by weight based on a total weight of the polyester polymer, and wherein the molar ratio between aromatic acids and aliphatic acids of said dicarboxylic acid in the chewing gum is between 0 and 1:4.2.

14. The chewing gum according to claim 13, wherein the polyester polymer is prepared by step-growth polymerization.

15. The chewing gum according to claim 13, wherein the polyester contains the components c) in an amount of from 1.0 to 5.0% by weight based on the total weight of the polyester.

16. The chewing gum according to claim 13, wherein the at least one polyester polymer has a molecular weight (Mw) of at least 40,000 g/mol.

17. A chewing gum comprising at least one polyester polymer, said polyester polymer comprising as polyester-forming components in condensed form:
a) at least one dicarboxylic acid,
b) at least one diol,
c) at least one compound having at least three groups capable of ester formation,
wherein the polyester polymer has a molecular weight (Mw) of at least 20,000 g/mol and comprises the components a) and b) in an amount of at least 90% by weight based on a total weight of the polyester polymer.

18. The chewing gum according to claim 17, wherein the polyester contains the components c) in an amount of from 1.0 to 5.0% by weight based on the total weight of the polyester.

19. The chewing gum according to claim 17, wherein the at least one polyester polymer has a molecular weight (Mw) of at least 40,000 g/mol.

20. The chewing gum according to claim 17, wherein the molar ratio between aromatic acids and aliphatic acids of said dicarboxylic acid in the chewing gum is between 0 and 1:4.2.
